(19) United States
(12) Patent Application Publication
(10) Pub. No.: US 2015/0273502 A1
(43) Pub. Date: Oct. 1, 2015

(54) Mist Spraying Hat

(71) Applicant: Norris Bell, Los Angeles, CA (US)

(72) Inventor: Norris Bell, Los Angeles, CA (US)

(21) Appl. No.: 14/671,986

(22) Filed: Mar. 27, 2015

Related U.S. Application Data
(60) Provisional application No. 61/971,184, filed on Mar. 27, 2014.

(51) Int. Cl. B05B 9/08

(52) U.S. Cl. CPC B05B 9/0816

(57) ABSTRACT

The present invention provides a mist spraying hat that is configured to spray a fluid on a wearer's face when the hat is positioned with the brim over the wearer's face. The hat includes a crown with a brim attached to a front portion thereof and a pump assembly. The pump assembly includes a fluid reservoir, a depressible bulb pump, an air line, spray nozzles, and water lines. The fluid reservoir is disposed on a back portion of the crown, wherein the depressible bulb pump disposed on the brim is connected thereto via the air line. The depressible bulb pump is configured to induce fluid stored within the fluid reservoir to be evacuated to the water lines to be dispersed by the spray nozzles. Preferably, the spray nozzles are disposed on the brim to allow fluid to be sprayed on the wearer's face as the hat is worn.

### CROSS REFERENCE TO RELATED APPLICATION

This application claims the benefit of U.S. Provisional Application No. 61/971184 filed on Mar. 27, 2014. The above identified patent application is herein incorporated by reference in its entirety to provide continuity of disclosure.

### BACKGROUND OF THE INVENTION

### Field of the Invention

The present invention relates to headwear. More specifically, the present invention pertains to an improved hat that includes a pump assembly configured to spray fluid in a mist form towards a wearer's face when the hat is placed with the brim positioned over the wearer's face.

Generally, when it is hot and humid outside, it can be very difficult to walk around, and even more difficult to exercise in such a condition. Whether it is walking, running, playing a pickup game of basketball, it is important to take proper precautions to prevent any heat-related illnesses. Exercising in hot weather puts extra stress on the body, wherein the body regulates heat by releasing sweat, which allows the body to cool itself. However, if the body no longer can cool itself, the core temperature within the body begins to rise and puts the internal organs and central nervous system at risk. Signs of potential heat exhaustion include general fatigue, weakness, nausea, dizziness, muscle cramps, and an increase in body temperature.

There are certain guidelines that are followed to exercise wisely in the heat. Some of these include staying hydrated and wearing breathable clothing that do not generate a lot of heat. However, these guidelines are generally effective for establishing certain precautions and do not help a person when he is in the middle of his workout without requiring him to stop midway through his workout. Therefore, there exists a need for a cooling device that aids a person in working through his entire workout without risking his health.

The present invention provides a mist spraying hat that is configured to spray a water mist towards a wearer's face to keep him cool and refreshed during hot days. The mist spraying hat comprises a crown having a brim attached to a front portion of the crown and a pump assembly. The pump assembly comprises a fluid reservoir storing a fluid, a depressible bulb pump, an air line, one or more spray nozzles, and one or more water lines. The depressible bulb pump is connected to the fluid reservoir and is configured to induce the fluid stored therein to evacuate to the water lines to be dispersed by the spray nozzles. The spray nozzles are disposed on a lower surface of the brim, which allows the fluid to be sprayed in mist form towards a wearer's face to keep cool and refreshed.

### SUMMARY OF THE INVENTION

In view of the foregoing disadvantages inherent in the known types of mist spraying hats now present in the prior art, the present invention provides a new and improved mist spraying hats wherein the same can be worn by a user with the brim of the hat placed in a position over the face and a pump assembly is configured to spray a fluid directed towards the user's face.

It is therefore an object of the invention to provide a new and improved mist spraying hat that has all of the advantages of the prior art and none of the disadvantages.

Another object of the present invention is to provide a new and improved mist spraying hat that includes a crown, a brim and a pump assembly configured to spray a fluid towards a user's face when the mist spraying hat is worn with the brim placed over the user's face.

Yet another object of the present invention is to provide a new and improved mist spraying hat, wherein the pump assembly includes a fluid reservoir storing a fluid, a depressible bulb pump, an air line, one or more spray nozzles, and one or more water lines.

Still yet another object of the present invention is to provide a new and improved mist spraying hat, wherein the depressible bulb pump is located on a lower surface of the brim and connected to the upper end of the fluid reservoir via the air line.

Another object of the present invention is to provide a new and improved mist spraying hat, wherein each of the spray nozzles are connected to the lower end of the fluid reservoir by the water lines.

Yet a further object of the present invention is to provide a new and improved mist spraying hat, wherein the depressible bulb pump induces the fluid to evacuate from the fluid reservoir towards the water lines to be dispersed through the spray nozzles.

A further object of the present invention is to provide a new and improved mist spraying hat that is easy to use.

Still yet another object of the present invention is to provide a new and improved mist spraying hat wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows side perspective of the present invention.

FIG. 2 shows a side perspective of the underside of the present invention.

FIG. 3 shows a transparent side perspective of the present invention.

### DETAILED DESCRIPTION OF THE INVENTION

References are made herein to the attached drawings. Like reference numerals are used throughout the drawings to depict like or similar elements of the mist spraying hat. For the purposes of presenting a brief and clear description of the present invention, the preferred embodiment will be discussed as worn by a user with the brim in a position over the user's face. The figures are intended for representative purposes only and should not be considered to be limiting in any respect.

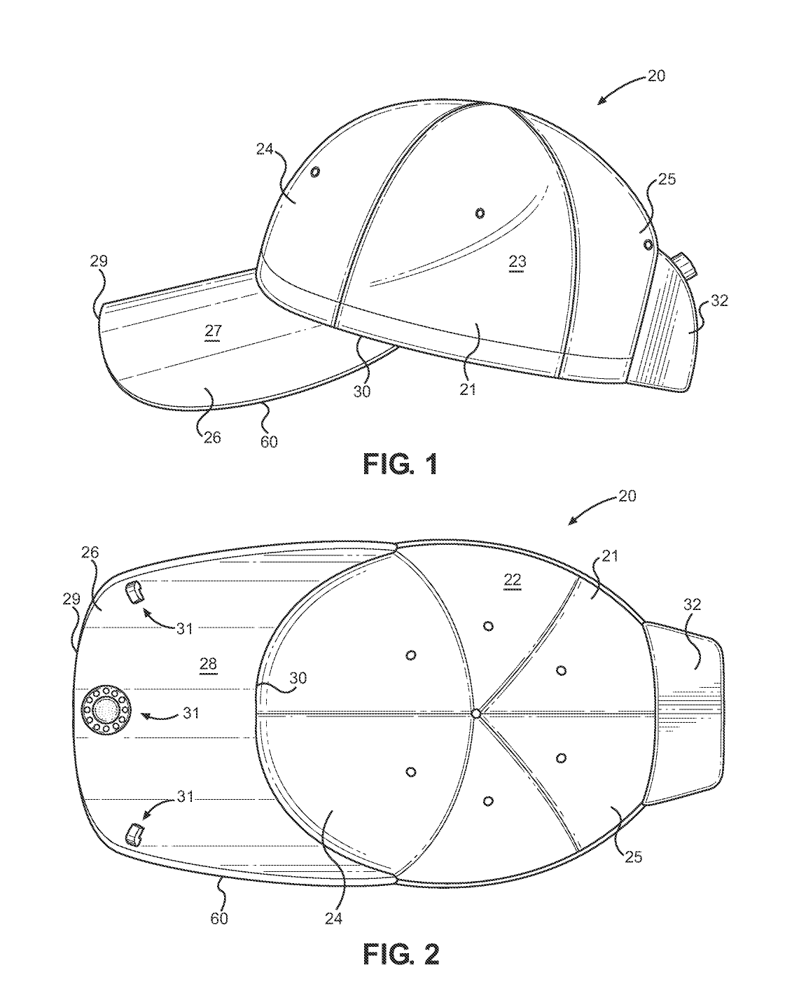

Referring now to FIGS. 1 and 2, there are shown a side perspective of the mist spraying hat 20 and a side perspective of the underside of the same. The mist spraying hat 20 comprises a crown 21 having an interior surface 22, a coextensive exterior surface 23, a front portion 24, and a back portion 25. The crown 21 substantially forms a semi-circular shape and an interior volume configured to receive a user's head. A brim 26 is attached to the front portion 24 of said crown having an upper surface 27, a coextensive lower surface 28, a front edge 29, a back edge 30, and opposing side edges 60, wherein the back edge 30 is attached to the front portion 24. Furthermore, the hat 20 comprises a pump assembly 31 configured to spray fluid towards a wearer's face when the brim 26 is in a position over the wearer's face. In this way, the hat 20 is particularly advantageous as it allows a wearer to stay cool and refreshed on hot days by spraying water mist on his face.

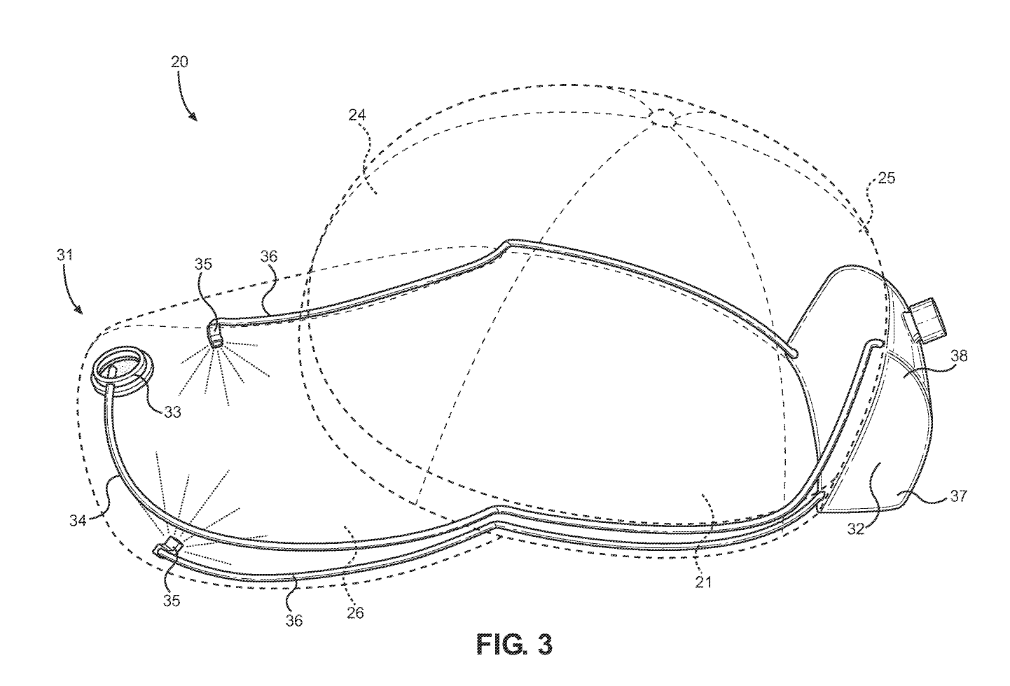

Referring now to FIG. 3, there is shown a transparent side perspective of the mist spraying hat 20. As aforementioned, the hat 20 includes a crown 21 having a brim 26 attached to the front portion 24 of the crown 21. The hat 20 further includes a pump assembly 31 comprising a fluid reservoir 32 storing a fluid, a depressible bulb pump 33, an air line 34, one or more spray nozzles 35 and one or more water lines 36, wherein the pump assembly 31 is configured to spray the fluid stored within the fluid reservoir 32 from the spray nozzles 35 located on the lower surface of the brim 26 towards a wearer's face when the wearer is wearing the hat 20 with the brim 26 situated over the wearer's face. The fluid reservoir 32 includes an upper end 37 and a lower end 38 configured to store the fluid, preferably water, therein. The fluid reservoir 32 is disposed on the back portion 25 of the crown 21, preferably centrally located on the back portion 25.

The depressible bulb pump 33 is disposed on the lower surface of the brim 26. Preferably, the depressible bulb pump 33 is disposed adjacent to the front edge 29 of the brim 26 in a centrally located position. The depressible bulb pump 33 is connected to the upper end 37 of the fluid reservoir 32 via the air line 34. Preferably, the depressible bulb pump 33 is bulb-shaped and hand actuated, however, other embodiments include other suitable types of pumps.

The spray nozzles 35 are connected to the lower end 38 of the fluid reservoir 32 via the one or more water lines 36. In the preferred embodiment, the pump assembly 31 includes a pair of spray nozzles 35, wherein each spray nozzle 35 is connected to the lower end 38 of the fluid reservoir 32 via its own water line 36. It is contemplated that some embodiments may be composed of one spray nozzle 35 and one water line 36, while other alternative embodiments may also be composed of three or more spray nozzles 35 with each spray nozzle 35 attached to its own water line 36.

The spray nozzles 35 and water lines 36 are configured such that the fluid stored within the fluid reservoir 32 can communicate from the fluid reservoir 32 to the spray nozzles 35. The depressible pump 33 is configured to induce the fluid to evacuate from the fluid reservoir 32 and towards the spray nozzles 35 through the water lines 36 by introducing air into the upper end 37 of the fluid reservoir. The depressible hand pump 33 is hand actuated and pressured to introduce ambient air into the air line 34 and the upper end 37 of the fluid reservoir 32, wherein the upper end 37 is above the fluid stored within the fluid reservoir 32. The pressurization then forces the fluid from the lower end 38 of the fluid reservoir 32 into the water lines 36 towards the spray nozzles 35 to be dispersed.

Preferably, the spray nozzles 35 are mist nozzles disposed adjacent to the opposing edges of the lower surface of the brim 26. In this way, the spray nozzles 35 are configured to spray downwards towards a wearer's face when the hat 20 is positioned around a wearer's head with the brim 26 over the wearer's face. However, it is contemplated that the spray nozzles 35 can be disposed anywhere on the lower surface of the brim 26, including on the front edge 29. It is also contemplated that the spray nozzles 35 can also include various shapes of spray, which can include a flat stream, hollow cone, and a full cone. Further yet, the spray angle of the spray nozzle 35 can also be altered in other embodiments including embodiments including spray nozzles 35 ranging with a 0° spray angle to a 65° spray angle.

Each spray nozzle 35 is connected to the lower end 38 of the fluid reservoir 32 via their own separate water line 36, which allows fluid communication between the fluid reservoir 32 to the spray nozzles 35. Preferably, there are a pair of spray nozzles 35 that are disposed adjacent to the opposing side edges of the lower surface of the brim 26. The depressible bulb pump 33 is disposed adjacent to the front edge of the lower surface of the brim 26 and is connected to the upper end 37 of the fluid reservoir 32 via the air line 34. The depressible bulb pump 33 is configured to introduce ambient air into the air line 34 and the upper end 37 of the fluid reservoir 32 to induce the fluid therein to evacuate into the water lines 36 to be dispersed by the spray nozzles 35. In this way, the hat 20 is particularly advantageous as it allows a wearer to stay cool during a hot day by spraying water mist towards his face.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A water misting hat, comprising:
said hat having a crown with an interior surface, a coextensive exterior surface, a front portion, and a back portion;
a brim attached to said front portion of said crown having an upper surface, a coextensive lower surface, a front edge, a back edge, and opposing side edges;
a pump assembly;
wherein said pump assembly comprises a fluid reservoir storing a fluid, a depressible bulb pump, an air line, one or more spray nozzles, and one or more water lines;
said one or more spray nozzles is located on said lower surface of said brim;
wherein said pump assembly is configured to spray said fluid from said spray nozzles on said lower surface of said brim towards a user's face while wearing said hat with said brim in a position over the user's face;
said fluid reservoir having an upper end and a lower end that is positioned on said back portion of said crown;
said depressible bulb pump being located on said lower surface of said brim and connected to said upper end of said fluid reservoir via said air line;
wherein each of said spray nozzles is connected to said lower end of said fluid reservoir via said water lines such that said fluid can communicate from said fluid reservoir to said spray nozzles;
wherein said depressible bulb pump is configured to induce said fluid to evacuate from said fluid reservoir and towards said spray nozzles to be dispersed by introducing air into said upper end of said fluid reservoir.

2) The water misting hat of claim 1, wherein said air line extends from said depressible bulb pump around said interior surface of said crown to said upper end of said fluid reservoir.

3) The water misting hat of claim 1, wherein each said water line extends from each of said one or more spray nozzles around said interior surface of said crown to said lower end of said fluid reservoir.

4) The water misting hat of claim 1, wherein said fluid is water.

5) The water misting hat of claim 1, wherein said spray nozzles are located adjacent to said opposing edges of said lower surface of said brim.

6) The water misting hat of claim 1, wherein said depressible hand pump is adjacent and centrally located along said forward edge on said lower surface of said brim.

7) The water misting hat of claim 1, wherein said depressible hand pump is configured to be hand actuated to introduce ambient air into said air line and said upper end of said fluid reservoir above said fluid, wherein pressurization forces said fluid from said lower end of said fluid reservoir into said one or more water lines and through said spray nozzles.

8) The water misting hat of claim 1, wherein said one or more spray nozzles are misting nozzles.

9) The water misting hat of claim 1, wherein said air line and said one or more air lines can extend along the sides of said interior surface of said crown or along a centerline of said interior surface of said crown.
